(19) United States
(12) Patent Application Publication
(10) Pub. No.: US 2006/0149730 A1
(43) Pub. Date: Jul. 6, 2006

(54) Client authenticated web browser with access approval mechanism

(76) Inventor: James Russell Curtis, Placerville, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/026,877

(22) Filed: Dec. 30, 2004

(51) Int. Cl. G06F 17/30

(52) U.S. Cl. 707/6

(57) ABSTRACT

Computer-implemented method for controlling access by a plurality of users to websites. The method includes receiving a first request that includes a first uniform resource locator (URL) from a first user of the plurality of users, the first URL identifying a first webpage. The method further includes ascertaining whether the first URL is part of a first set of URLs, the first set of URLs being associated with the first user. The method additionally includes obtaining, if the first URL is not part of the first set of URLs, an acknowledgment from the first user that the first user is requesting to access the first webpage.

### BACKGROUND OF THE INVENTION

Browsers are used today to access websites via the network. To facilitate discussion, FIG. 1 shows a computer 100 executing a browser program. The browser program is shown by a window 102 on a display screen 104 of computer 100. Using a browser, a user can connect through a communication channel 106 to a network. As discussed herein, a network relates to a system of computers or servers interconnected by wires or other means in order to share information. A network may relate to an intranet (which is a privately maintained computer network that can be accessed only by authorized persons, especially members or employees of the organization that owns it) or an external network (such as internet).

As the network grows, controlling access to websites has become desirable to administrator. One reason relates to the increased number of websites with objectionable materials (i.e., pornography). Another reason relates to restricting access to certain websites, especially those associated with internal intranet. Thus, unfettered access may result in, for example, the abuse of internet privileges and potential liability from sexual harassment lawsuits.

One solution has been to prevent website access completely. However, inhibiting access to all websites is impractical since some websites may contain useful information or even required information. Consider, for example, a company whose benefits administration has been outsourced to a third party administrator. In such a situation, employees in this company need to be able to access the benefits website. However, if the company restricts access to the network, then the employees are not able to access the benefits website to obtain needed information regarding, for example, the company-offered health benefits.

Another solution is to allow unrestricted access to the network, trusting that the user will not access inappropriate sites. Though most employees will appropriately use external internet access, a portion of employees may abuse this trust. Additionally, there is the potential liability of sexual harassment lawsuits for the employer if an employee accesses a pornographic website and displays on his/her screen pornographic images that others may construe to be offensive. Another problem with unrestricted access relates to a lack of an efficient method for measuring the extent of the abuse.

In the prior art, various approaches have been attempted to control user access to websites. One approach involves using tracking software to track user's access. However, the use of tracking software has a few problems. First, most tracking software has to be maintained with a list of ‘red flag’ sites, i.e., sites considered to be off-limit. Maintaining a list of ‘red flag’ sites may be laborious, particularly if some sites are off-limit to some users but not to others. Further, someone has to comb through the logs to find offenders. Typically, however, the identification points to a specific computer instead of a particular user (e.g., “John's computer” instead of “John”. Once identified, the computer user (e.g., John) may claim that it was an accident that he visited the offending site or that he was not using the identified computer at that time and that the unauthorized access was performed by someone else (e.g., someone other than John himself) via the identified computer (e.g., John's computer).

Another mechanism involves preventing users from accessing objectionable websites. However, these mechanisms often just block out a list of identified sites or search for key words on the site such as ‘sex’ to determine if the site should be displayed. These mechanisms are however easily circumvented by objectionable website creators and they are time-consuming to maintain. Additionally, these mechanisms can prevent access to legitimate sites. For example, sites that provide health benefits information often maintain the gender information of the insured using the keyword “sex”. If the blocking mechanism blocks out sites that contain the word “sex,” an employee may be prevented from accessing a legitimate human resource-related site

### SUMMARY OF INVENTION

The invention relates, in an embodiment, to a computer-implemented method for controlling access by a plurality of users to websites. The method includes receiving a first request that includes a first uniform resource locator (URL) from a first user of the plurality of users, the first URL identifying a first webpage. The method further includes ascertaining whether the first URL is part of a first set of URLs, the first set of URLs being associated with the first user. The method additionally includes obtaining, if the first URL is not part of the first set of URLs, an acknowledgment from the first user that the first user is requesting to access the first webpage.

In another embodiment, the invention relates to an article of manufacture comprising a program storage medium having computer readable code embodied therein. The computer readable code is configured to control access by a plurality of users to websites. There is included computer readable code for receiving a first request that includes a first uniform resource locator (URL) from a first user of the plurality of users, the first URL identifying a first webpage. There is further included computer readable code for ascertaining whether the first URL is part of a first set of URLs, the first set of URLs being associated with the first user. Additionally, there is included computer readable code for obtaining, if the first URL is not part of the first set of URLs, an acknowledgment from the first user that the first user is requesting to access the first webpage.

In yet another embodiment, the invention relates to a computer-implemented arrangement for controlling access by a first user to websites. There is included means for receiving a first request that includes a first uniform resource locator (URL) from the first user, the first URL identifying a first webpage. There is further included means for storing a first set of URLs, the first set of URLs being associated with the first user, the first set of URLs representing at least URLs associated with webpages that the first user already visited previously. Additionally, there is included means for ascertaining whether the first URL is part of the first set of URLs, and for obtaining self-authentication data from the first user, if the first URL is not part of the first set of URLs, the self-authentication data indicating that the first user is requesting to access the first webpage.

These and other features of the present invention will be described in more detail below in the detailed description of various embodiments the invention and in conjunction with the following figures.

### BRIEF DESCRIPTION OF THE DRAWINGS

The present invention is illustrated by way of example, and not by way of limitation, in the figures of the accompanying drawings and in which like reference numerals refer to similar elements and in which:

Prior art FIG. 1 shows a computer executing a browser program.

FIG. 2 shows, in accordance with an embodiment of the present invention, a self-maintained access control mechanism residing within a browser and/or working in cooperation with a browser.

FIG. 3 shows, in accordance with an embodiment of the invention, stricter control over accessibility to web sites may be provided via the self-maintained access control mechanism with administrator approval.

FIG. 4 shows, in accordance with an embodiment of the invention, a logical representation of the self-maintained access control mechanism residing within a browser and/or working in cooperation with a browser.

FIG. 5A shows, in accordance with an embodiment of the invention, the logical representation of FIG. 4 with the additional steps that occur when administrator's approval is required before a user is granted access to a URL that a user has not previously visited.

FIG. 5B shows, in accordance with an embodiment of the invention, the steps for a user to gain access to a URL when administrator approval is needed.

FIG. 6 shows, in accordance with an embodiment of the present invention, how the self-maintained access control arrangement may be installed.

### DETAILED DESCRIPTION OF VARIOUS EMBODIMENTS

The present invention will now be described in detail with reference to various embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

Various embodiments are described hereinbelow, including methods and techniques. It should be kept in mind that the invention might also cover articles of manufacture that includes a computer readable medium on which computer-readable instructions for carrying out embodiments of the inventive technique are stored. The computer readable medium may include, for example, semiconductor, magnetic, opto-magnetic, optical, or other forms of computer readable medium for storing computer readable code. Further, the invention may also cover apparatuses for practicing embodiments of the invention. Such apparatus may include circuits, dedicated and/or programmable, to carry out tasks pertaining to embodiments of the invention. Examples of such apparatus include a general purpose computer and/or a dedicated computing device when appropriately programmed and may include a combination of a computer/computing device and dedicated/programmable circuits adapted for the various tasks pertaining to embodiments of the invention.

In accordance with embodiments of the present invention, there are provided methods and arrangements for a self-maintained access control mechanism that may reside within a browser or in cooperative arrangement with a browser. Unlike the prior art, the self-maintained access control mechanism does not require an administrator to maintain and update the list of prohibited sites.

In an embodiment, the self-maintained access control mechanism allows a user to request for access to a new site via a browser. In an embodiment of the invention, the user may be granted access to a new site upon self-authentication. As describe herein, self-authentication involves providing data (i.e., password, pin, personal data, thumb or handprint scan, retina scan, facial biometric scan, etc.) that only the user knows or that is unique to the user. Requiring the use of self-authentication data to access new sites prevents the user from later claiming that access is accidental. Further, a self-maintained access control mechanism allows the user to access previously accessed sites without the need for self-authentication.

In an embodiment, the user access is queued for administrator approval after self-authentication. The administrator approval ensures that attempts to access inappropriate sites are prevented before they can occur. In an embodiment of the invention, the administrator can audit, either periodically or upon the occurrence of certain triggering events, the list of accessed sites and can take disciplinary action against users who access inappropriate sites. The inventive self-maintained access control mechanism is compatible with existing browsers and network infrastructure, thus, reducing implementation cost and effort.

The self-maintained access control mechanism without administration control may be particularly useful to employers, such as corporations. This mechanism provides corporate control without increasing the burden of requiring active approval by the administrator for each URL that a user has not visited before. Further, a self-maintained access control mechanism allows the user to access previously accessed sites without the need for self-authentication. However, access to a particular URL may be rescinded by the administrator if a site is deemed inappropriate. Also, as mentioned above, self-maintained access control mechanism requires self-authentication by the user; thus, the user is unable to claim that accessing a site was an accident.

Self-maintained access control mechanism with administrator approval may be highly useful to parents in controlling children's access to inappropriate sites. Using the inventive mechanism, parents can ensure that sites that have not been approved for a particular child must first be screened by the parents before access is allowed. Further, parents have the ability to control site accessibility on a child-by-child basis. As a result, a child who is six has a different list of approved sites from a sibling who may be sixteen.

The following example illustrates, in an embodiment, how a self-maintained access control arrangement may work. A user launches a browser to access a website. Before the user is allowed access to the site, the client authentication module (CAM) requires the user to enter a user identification (such as a user name). Once the CAM receives the user identification, the CAM compares the user identification against a database of user identifications located in a user configuration file (UCF). If the user identification is an entry in the UCF, the user is allowed to begin browsing. However, if the user identification is not an entry in the UCF, the user is not allowed to access the network. In an embodiment, the user is provided with details on how a user account can be set up if the user wishes to sign up and access the network.

For the user that is able to browse, the CAM compares the uniform resource locator (URL) requested against a database of URLs stored on a site access file (SAF). In the SAF, there may be a list of URLs associated with each user identification. This list contains those URLs which the user had been approved for or which the user has previously visited. If the URL requested by the user is in the SAF, then the user is granted access to the site. However, if the URL requested by the user is not in the SAF, the user may then be required to provide acknowledgement via self-authentication. Self-authentication may include providing a password or Personal Identification Number (PIN), personal data, thumb or handprint scan, retina scan, facial biometric scan, etc. The URL requested is added to the list associated with the user identification in the SAF. The user is then granted access to the requested site.

In an embodiment of the invention, access to an unapproved website requires administrator approval. Using the above example, suppose the user has requested access to a site that is not located in the SAF. Client site request module (CSRM) inquires whether the user would like to request access to the site. If the user responds affirmatively, the user would provide acknowledgement via self-authentication. The entry of the self-authentication data may act as the affirmative response, or it may be entered to identify the user after the user has responded affirmatively. The CSRM then adds the URL to a requested site queue (RSQ) and access to the requested site is postponed until approval is granted by the administrator. In an embodiment, an email is sent to the administrator to inform the administrator of the request. The administrator is then provided with a list of outstanding requests by the master site approval module (MSAM). The administrator may approve or deny the request. In either case, the user may be informed of the administrator decision via email. If approved, the URL is also added to the approved site file and access by the user may occur.

Generally speaking, the task of initializing the inventive self-maintained access control mechanism may be performed by the administrator. First, the components are installed inside a browser (such as Microsoft Explorer, Netscape, Mozilla, etc.). Then the administrator may populate the user configuration file with the list of users. The administrator has the option of setting up a temporary acknowledgement (such as password) with each user identification. In an embodiment, the administrator may populate the site access file with a white list of approved URLs (such as pre-approved URLs that may be globally available to all users or pre-approved URLs that may be associated with specific user identifications). Thereafter, users may begin employing the self-maintained access control mechanism to request access to sites.

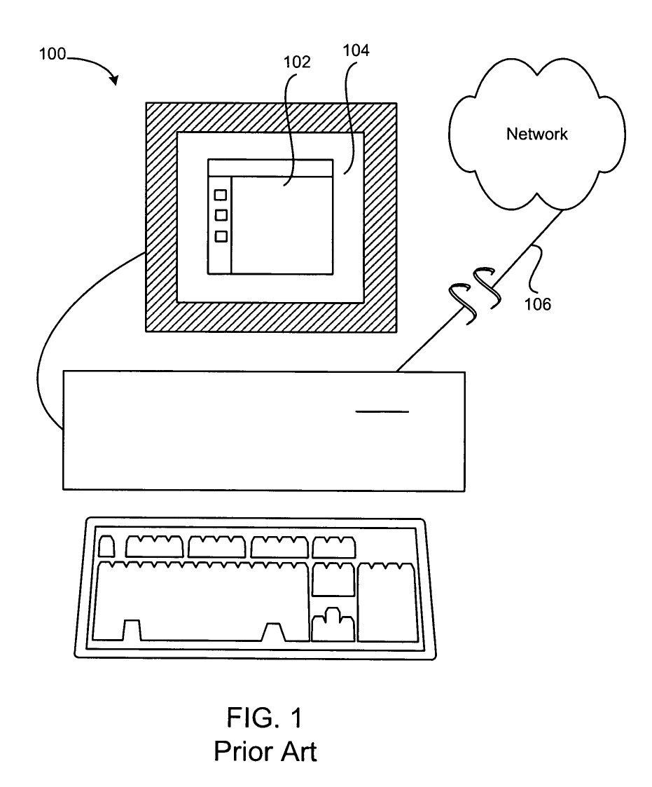

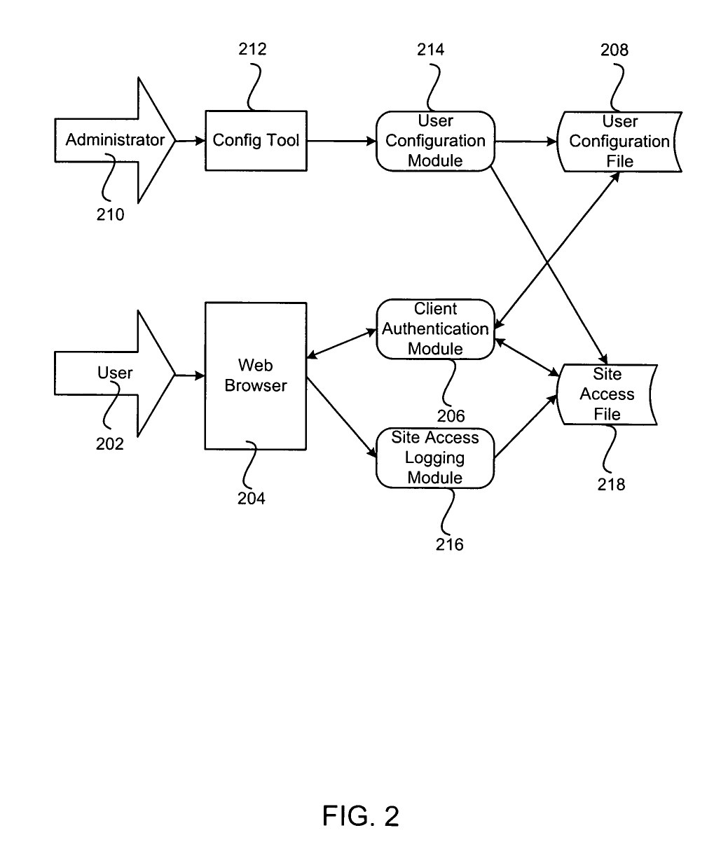

The features and advantages of embodiments of the invention may be better understood with reference to the figures and discussions that follow. FIG. 2 shows, in accordance with an embodiment of the present invention, a self-maintained access control mechanism residing within a browser and/or working in cooperation with a browser. As the term is employed herein, a browser may represent a browsing program employed to access the network, which browsing program may reside on a desktop computer, a laptop computer, a handheld computer (popularly known as a palm-top computer), a cellular phone that is capable of accessing sites in a network, or a portable drive (i.e. flash drive). A user 202 activates a browser 204 to begin a network session. A client authentication module (CAM) 206 prompts user 202 for a user identification. Once user 202 provides a user identification, CAM 206 compares the user identification against the plurality of user identifications stored in a user configuration file (UCF) 208. If the user identification is located in UCF 208, user 202 is allowed to continue browsing the network. However, if the user identification is not located in UCF 208, then user's 202 network session may be terminated and user 202 may be notified by CAM 206 that a user identification must first be established via a master administrator 210.

To create a new user account, master administrator 210 uses configuration tool 212 to load user configuration module 214. With user configuration module 214, master administrator 210 is able to create a new user account in the UCF 208. In an embodiment of the invention, a temporary acknowledgement (such as a password) may be assigned to the new user identification.

Once user 202 has been authenticated against UCF 208, user 202 may begin browsing the network. The URL that user 202 wants to visit is first verified by CAM 206. CAM 206 compares each URL address request against the plurality of URLs stored in SAF 218. If the URL requested is found in the list of URLs associated with user 202 (via user identification) in SAF 218, then user 202 is allowed access to the URL.

If the URL requested is not found in the list of URLs associated with user 202 in SAF 218, then CAM 206 informs user 202 that the URL is an address that user 202 has not previously visited. CAM 206 then prompts user 202 for an acknowledgement (such as a password, a PIN, personal data, thumb or handprint scan, retina scan, facial biometric scan, etc.). Acknowledgement requires user 202 to self-authenticate and consent to visit the URL. Once acknowledgment is received by CAM 206, the new URL is added to SAF 218 via a site access logging module (SALM) 216 and user 202 is allowed access to the URL.

In an embodiment of the invention, if a password is the method by which acknowledgement is received, CAM 206 prompts for a password when user 202 visit a URL that the user has not previously visited. Upon receiving the password from user 202, CAM 206 then compares the password entered by user 202 against the password associated with that user's user identification, which is stored on UCF 208. If the two passwords match, then the URL is added to SAF 218 with the user identification as the key (via the SALM 216) and user 202 is allowed to access the URL.

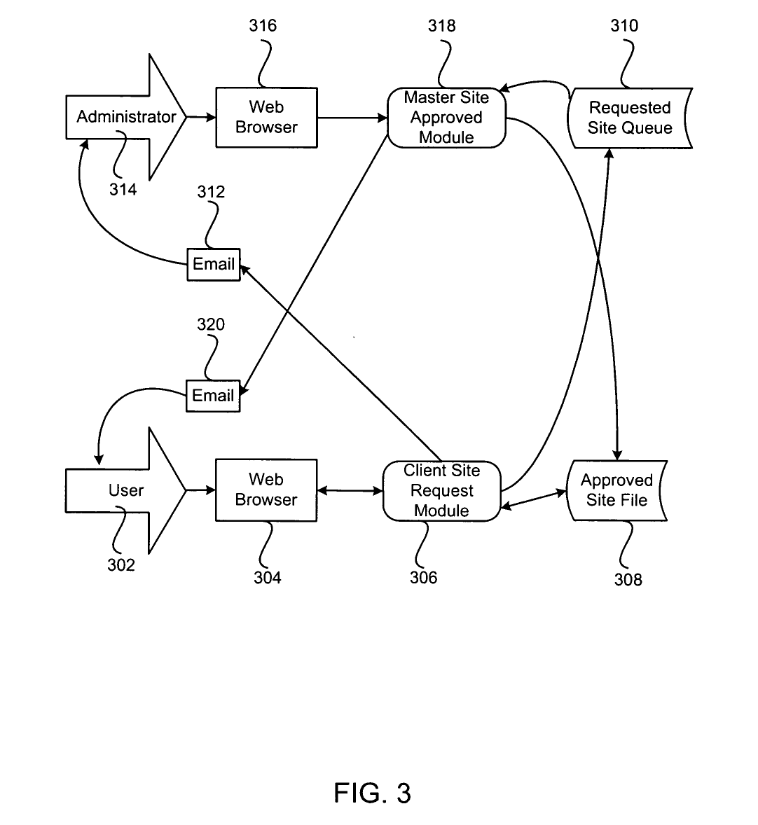

In an embodiment of the invention, stricter control over accessibility to web sites may be provided via the self-maintained access control mechanism with administrator approval. In this embodiment of FIG. 3, user 302 accesses a site via a web browser 304. Upon activating web browser 304, client site request module (CSRM) 306 compares the URL requested against the plurality of URLs stored in the approved site file (ASF) 308 using the user identification as the key. If the URL is found, the user accesses the web sites without any visible interference.

However, if the URL is not found in the list of URLs associated with the user identification in ASF 308, then CSRM 306 requires acknowledgement from user 302 before CSRM 306 can add the URL to requested site queue (RSQ) 310. In an embodiment, an email 312 pertaining to the outstanding request is sent by CSRM 306 to administrator 314.

When administrator 314 activates web browser 316, master site approval module 318 provides a list of outstanding request from RSQ 310. Administrator 314 then has the option of visiting the sites prior to determining whether site access should be approved. If the site is approved then the site is added to ASF 308 with the user identification as a key. In an embodiment of the invention, user 302 is notified via email 320 of the approved or denied status.

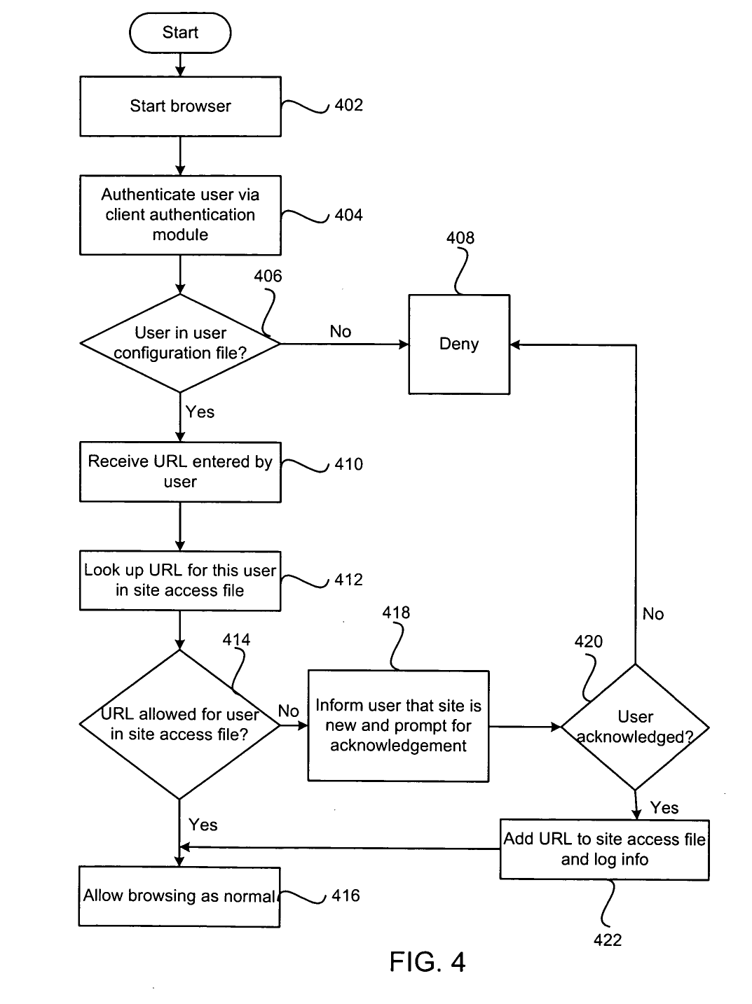

To have a better understanding of the method that may be used to implement self-maintained access control mechanism from a user's perspective, FIG. 4 is provided. FIG. 4 flowchart is best understood in reference to FIG. 2. User 202 (FIG. 2) starts the browser in step 402 to access the web content. At step 404, CAM 206 (FIG. 2) authenticates user 202 (FIG. 2) by requesting for user identification. At step 406, CAM 206 (FIG. 2) accesses UCF 208 (FIG. 2) to determine if user identification is an entry in UCF 208 (FIG. 2). If the user identification is not in UCF 208 (FIG. 2) then user 202 (FIG. 2) at step 408 is denied access to the network.

However, if user identification is an entry in UCF 208 (FIG. 2), at step 410, CAM 206 (FIG. 2) receives the URL that user 202 (FIG. 2) entered. At step 412, CAM 206 (FIG. 2) compares the URL entered against a list of URLs in SAF 218 (FIG. 2) associated with user identification. At step 414, if the URL is not associated with the user identification in SAF 218 (FIG. 2), then CAM 206 (FIG. 2) informs user 202 (FIG. 2) that the site is new and not associated with the user identification in SAF 218 (FIG. 2). CAM 206 (FIG. 2) prompts user 202 (FIG. 2) to provide acknowledgement (such as personal data, password, thumb or handprint scan, retina scan, facial biometric scan, etc.). At step 420, if user 202 (FIG. 2) does not provide acknowledgement then user 202 (FIG. 2) is denied access at step 408. However, if user 202 (FIG. 2) provides active acknowledgement CAM 206 (FIG. 2) adds the URL to SAF 218 (FIG. 2) and associates the URL to the user identification. At step 416, user 202 (FIG. 2) is able to access the URL.

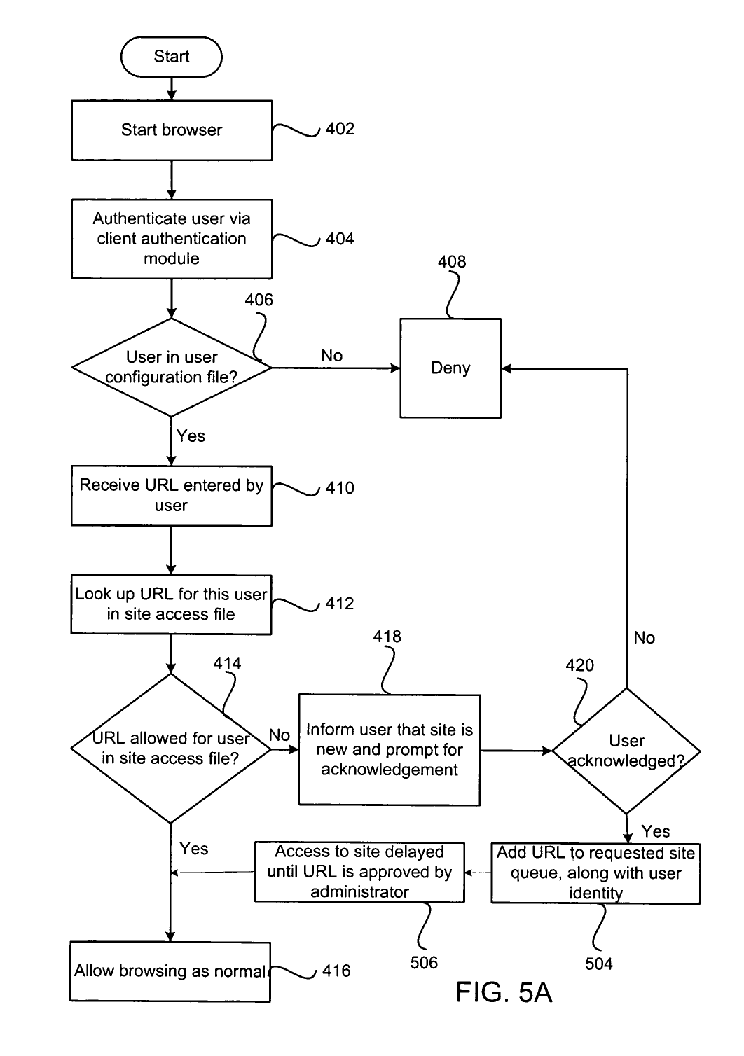

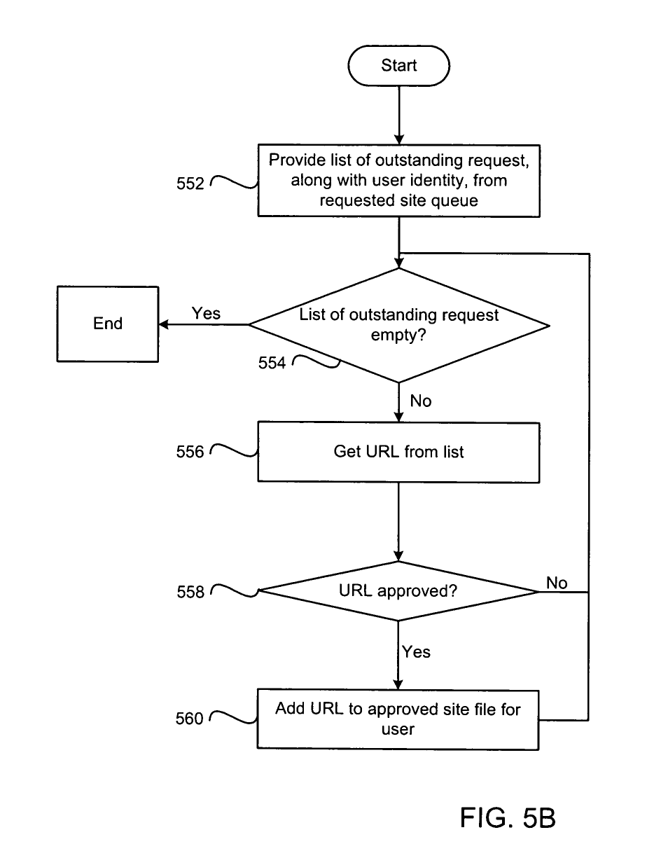

FIG. 5A is similar to FIG. 4 except that FIG. 5A shows, in an embodiment of the invention, the additional steps that occur when administrator's approval is required before a user is granted access to a URL that a user has not previously visited. In FIG. 4 at step 420, the user is allowed immediate access to a new URL upon providing acknowledgement. However, in FIG. 5A, user 302 (FIG. 3) does not get immediate access to the new URL upon providing acknowledgement. Instead, CSRM 306 (FIG. 3) adds the URL with user identification to RSQ 310 (FIG. 3) upon receiving user's 302 (FIG. 3) acknowledgement. At step 506, user 302 (FIG. 3) is unable to access the URL until approval is granted by the administrator.

FIG. 5B shows, in an embodiment of the invention, the steps for a user to gain access to a URL when administrator approval is needed. At step 552, such as administrator 314 (FIG. 3) accesses the network and is provided a list of outstanding requests, along with user identifications, such as from RSQ 310 (FIG. 3). If the list of outstanding requests is empty at step 554, then the process ends at step 555. However, if the list of outstanding requests is not empty, then at step 556, the administrator is provided a list of outstanding URLs. The administrator reviews each URL in the list of outstanding requests and determines which URLs are approved and which ones are denied. If the first URL is not approved at step 558, the administrator returns back to step 554 to access the list of outstanding URLs to grab the next URL in the list. If the URL is approved, then the URL is added to approved site file (e.g., 308 (FIG. 3)) and the administrator returns to step 554 to access the list of outstanding URLs to retrieve the next URL in the list. The administrator will continue through this process until all URLs have been reviewed.

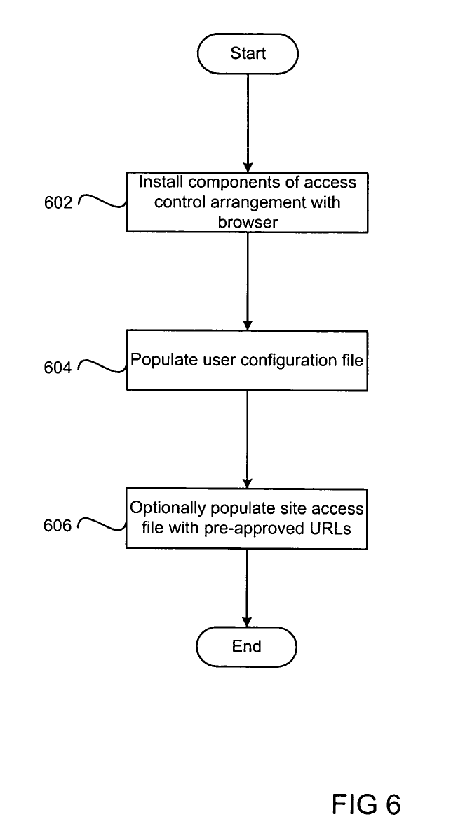

FIG. 6 illustrates, in an embodiment of the invention, how the self-maintained access control arrangement may be installed. At step 602, the administrator installs components of the self-maintained access control arrangement within the browser. These components may include a configuration tool, a user configuration module, a client access module, a site access log module, a user configuration file and a site access file. At step 604, the administrator populates the user configuration file with user related information such as user identification and temporary acknowledgement (i.e., password). At next step 606, the administrator has the option of populating the site access file with a white list of approved URLs. One way to populate the site access file is to include a list of sites that are accessible by all users (i.e., CNN, Google, Yahoo, etc.). Another way to populate the site access file is to specify on a user-by-user basis the sites that are accessible by a specific user.

As can be appreciated from the foregoing, embodiments of the invention allows an organization to control access to the network to prevent internet privileges abuses and potential liability from sexual harassment lawsuits without inhibiting user's access. First, the self-maintained access control mechanism allows an organization to enable the users to access the network without inhibiting access to any specific website via self-authentication. Second, an administrator is not burden with maintaining a list of inappropriate websites. Moreover, the organization is able to access the log to identify the users who access inappropriate websites and the organization can discipline the offenders with confidence.

Another embodiments of the invention allows for a stricter web-environment in which administrator's approval has to be granted prior to accessing a site that a user has not previously visited. This embodiment may be highly useful for parental control purposes, for example. First, parents have the option of reviewing the website before a child can access the site. Second, parents have the ability to set websites accessibility on a child-by-child basis. Thus, a child that is sixteen may access sites that his/her sibling of six years old may not.

While this invention has been described in terms of several embodiments, there are alterations, permutations, and equivalents, which fall within the scope of this invention. It should also be noted that there are many alternative ways of implementing the methods and apparatuses of the present invention. It is therefore intended that the following appended claims be interpreted as including all such alterations, permutations, and equivalents as fall within the true spirit and scope of the present invention.

What is claimed is:

1. A computer-implemented method for controlling access by a plurality of users to websites, comprising:
receiving a first request that includes a first uniform resource locator (URL) from a first user of said plurality of users, said first URL identifying a first webpage;
ascertaining whether said first URL is part of a first set of URLs, said first set of URLs being associated with said first user;
if said first URL is not part of said first set of URLs, obtaining an acknowledgment from said first user that said first user is requesting to access said first webpage.

2. The computer-implemented method of claim 1 further comprising:
adding said first URL to said first set of URLs after said obtaining said acknowledgement; and
permitting said first user to access said first webpage after obtaining said acknowledgement.

3. The computer-implemented method of claim 2 wherein said acknowledgement represents a password specifically associated with said first user.

4. The computer-implemented method of claim 1 further comprising:
adding said first URL to a requested site queue after said obtaining said acknowledgement;
presenting at least a portion of said requested site queue for approval by an administrator other than said first user; and
permitting said first user to access said first webpage only after said administrator approves said request for accessing said first webpage.

5. The computer-implemented method of claim 4 further comprising alerting said administrator after said adding.

6. The computer-implemented method of claim 1 further comprising:
prior to said ascertaining whether said first URL is part of said first set of URLs, ascertaining whether said first URL is part of a white list of URLs, said white list of URLs representing URLs that are acceptable for access by all users; and
if said first URL is part of said white list of URLs, permitting said first user to access said first webpage irrespective whether said first URL is part of said first set of URLs.

7. The computer-implemented method of claim 1 further comprising:
receiving a second request that includes a second uniform resource locator (URL) from a second user of said plurality of users, said second URL identifying a second webpage; and
ascertaining whether said second URL is part of a second set of URLs, said second set of URLs being associated with said second user, said second set of URLs being different from said first set of URLs;
if said second URL is not part of said second set of URLs, obtaining an acknowledgment from said second user that said second user is requesting to access said second webpage.

8. The method of claim 1 further comprising informing said first user responsive to said ascertaining that said first URL is not part of said first set of URLs prior to asking said user for said acknowledgment.

9. An article of manufacture comprising a program storage medium having computer readable code embodied therein, said computer readable code being configured to control access by a plurality of users to websites, comprising:
computer readable code for receiving a first request that includes a first uniform resource locator (URL) from a first user of said plurality of users, said first URL identifying a first webpage;
computer readable code for ascertaining whether said first URL is part of a first set of URLs, said first set of URLs being associated with said first user;
computer readable code for obtaining, if said first URL is not part of said first set of URLs, an acknowledgment from said first user that said first user is requesting to access said first webpage.

10. The article of manufacture of claim 9 further comprising:
computer readable code for adding said first URL to said first set of URLs after said obtaining said acknowledgement; and
computer readable code for permitting said first user to access said first webpage after obtaining said acknowledgement.

11. The article of manufacture of claim 10 wherein said acknowledgement represents a password specifically associated with said first user.

12. The article of manufacture of claim 9 further comprising:
computer readable code for adding said first URL to a requested site queue after said obtaining said acknowledgement;
computer readable code for presenting at least a portion of said requested site queue for approval by an administrator other than said first user; and
computer readable code for permitting said first user to access said first webpage only after said administrator approves said request for accessing said first webpage.

13. The article of manufacture of claim 12 further comprising alerting said administrator after said adding.

14. The article of manufacture of claim 9 further comprising:
computer readable code for ascertaining, prior to said ascertaining whether said first URL is part of said first set of URLs, whether said first URL is part of a white list of URLs, said white list of URLs representing URLs that are acceptable for access by all users; and
computer readable code for permitting, if said first URL is part of said white list of URLs, said first user to access said first webpage irrespective whether said first URL is part of said first set of URLs.

15. The article of manufacture of claim 9 further comprising:
computer readable code for receiving a second request that includes a second uniform resource locator (URL) from a second user of said plurality of users, said second URL identifying a second webpage; and
computer readable code for ascertaining whether said second URL is part of a second set of URLs, said second set of URLs being associated with said second user, said second set of URLs being different from said first set of URLs;
computer readable code for obtaining, if said second URL is not part of said second set of URLs, an acknowledgment from said second user that said second user is requesting to access said second webpage.

16. A computer-implemented arrangement for controlling access by a first user to websites, comprising:
means for receiving a first request that includes a first uniform resource locator (URL) from said first user, said first URL identifying a first webpage;
means for storing a first set of URLs, said first set of URLs being associated with said first user, said first set of URLs representing at least URLs associated with webpages that said first user already visited previously; and
means for ascertaining whether said first URL is part of said first set of URLs, and for obtaining self-authentication data from said first user, if said first URL is not part of said first set of URLs, said self-authentication data indicating that said first user is requesting to access said first webpage.

17. The computer-implemented arrangement of claim 16 further comprising:
means for adding said first URL to said first set of URLs after said obtaining said self-authentication data, whereby said first user is permitted to access said first webpage only after furnishing said self-authentication data.

18. The computer-implemented arrangement of claim 16 further comprising:
means for adding said first URL to a requested site queue after said obtaining said self-authentication data, whereby said first user is permitted to access said first webpage only after said administrator approves said request to access said first webpage in said requested site queue.

19. The computer-implemented arrangement of claim 16 wherein said self-authentication data represents a password specifically associated with said first user.

20. The computer-implemented arrangement of claim 16 wherein said self-authentication data represents a personal identification number (PIN).
